(19) United States
(12) Patent Application Publication
(10) Pub. No.: US 2013/0294105 A1
(43) Pub. Date: Nov. 7, 2013

(54) LIGHT ELEMENT HAVING A TARGETED INFLUENCE ON EDGE OPTICS

(71) Applicant: Audi AG, Ingolstadt (DE)

(72) Inventor: Jens Dietmar Reuschel, Ingolstadt (DE)

(21) Appl. No.: 13/875,628

(22) Filed: May 2, 2013

(30) Foreign Application Priority Data
May 3, 2012 (DE) 10 2012 008 976.7

(51) Int. Cl. F21V 8/00; F21S 8/10

(52) U.S. Cl. CPC G02B 6/0096; F21S 8/10
USPC 362/558

(57) ABSTRACT

A light element for ambient illumination, having a light distribution plane and a main scatter plane, wherein an angle between a surface normal of the main scatter plane and a surface normal of the light distribution plane is between 10° and 80°.

### CROSS-REFERENCES TO RELATED APPLICATIONS

This application claims the priority of German Patent Application, Serial No. 10 2012 008 976.7, filed May 3, 2012, pursuant to 35 U.S.C. 119(a)-(d), the disclosure of which is incorporated herein by reference.

### BACKGROUND OF THE INVENTION

The present invention relates to a light element for ambient illumination.

The following discussion of related art is provided to assist the reader in understanding the advantages of the invention, and is not to be construed as an admission that this related art is prior art to this invention.

With known light conductors, cavities of certain fixtures such as cup-holders cannot be illuminated evenly and glare-free in the desired manner. A radiation in radial direction is not glare-free; and with a radiation in axial direction, a ring-shaped illumination of the cavity can be achieved at best. The ring-shaped illumination on the bottom of the cup-holder is not always desired because this reveals a structure which does not correspond to the appearance of the cup-holder at daylight and whose esthetic does not necessarily fit the design goals for the interior fixtures.

It would therefore be desirable and advantageous to provide a light element with which a more even illumination of a cavity of a fixture can be achieved or with which an illumination of a fixture can be designed more creatively than is possible with known light conductors.

### SUMMARY OF THE INVENTION

According to one aspect of the present invention, a light element for ambient illumination includes a light distribution plane, a main light scatter surface, a first broadside and a second broadside, wherein an angle between a surface normal of the main scatter surface and a surface normal of the light distribution plane is between 10° and 80°, wherein the first and second broadsides are arranged essentially parallel to one another, and wherein the main scatter surface forms a bevel between a curved portion of the first broadside and the second broadside.

According to another advantageous feature of the invention, the light element has a light distribution plane and a main scatter plane, wherein an angle between a surface normal of the main scatter surface and a surface normal of the light distribution plane is between 10° and 80°. The light element has a first and a second broadside. The two broadsides are arranged essentially parallel to one another. The main scatter surface extends along a curved portion of the first broadside. The curve radius of the curved portion is at least of a size so that the light element has the property, that when visible light is radiated into the light distribution plane of the light element, leakage radiation losses of light beams which are guided up to the first cross-section at a beginning of the curved portion, on a way between the first cross-section of the light element up to a second cross-section of the light element which is located directly in front of the main scatter surface but does not include a part of the main scatter surface, is not more than 50%, preferably not more than 10%, particularly preferable not more than 5%.

It is preferred when the light element has the following properties: when visible light is radiated into a side surface of the light element, which is opposite the main scatter surface, at least four times more light (preferably at least eight times) leaves the light element via the main scatter surface than light from the radiated-in light leaves the light element via other outer surfaces of the light element.

According to another aspect of the invention a fixture for a vehicle includes a light conducting element according to the invention.

According to yet another aspect of the invention, a motor vehicle includes a fixture and/or a light element according to the invention.

By selecting the angle between the surface normal of the main scatter surface and the surface normal of the light distribution plane, it is possible with the proposed light element, to define radiation directions and radiation intensities of the main scatter surface freely and to achieve almost any conceivable illumination distribution of a cavity of a fixture. In particular, by means of structuring the main scatter surface (for example for a Fresnel lens or a micro lens array) radiation directions of the main scatter surface can be determined more accurately, when surface normals of the main scatter surface point in directions into which the light is to be radiated. A ring-shaped main scatter surface can typically have the shape of a surface of a sheath of an imagined frustrum. The main longitudinal axis of the imagined frustrum can correspond with the surface normal of the light distribution plane of the light element. The light element can also be used as light distributor for a reading light, a glove compartment light or a ceiling light (for example in a cargo space or in a trunk).

In a preferred embodiment, the light element has a first and a second broadside, wherein the two broadsides are arranged essentially parallel to one another. This allows cost effective manufacture of a light element which enables an optimal light conduction. Preferably, the first and/or second broadsides are even.

Preferably, the main scatter plane extends along a curved portion of the first broadside, wherein the main scatter plane has a scatter effect for visible light per surface unit, which is at least four times the scatter effect of the curved portion for visible light per surface unit. This allows efficient conduction of light (i.e., with relatively low leakage loss) to the main scatter surface, without substantially changing an appearance of the light element in the region of the scatter element, as it would be the case for example when mirroring was involved.

According to another advantageous feature of the invention, the light element has a first cross section at a beginning of the curved portion and a second cross section directly in front of, but not including a portion of the main scatter surface, and wherein a curve radius of the curved portion is at least of a size so that leakage losses between the first and second cross sections of visible light radiated into the light distribution plane of the light element, are not more than 15%, preferably not more than 10%, particularly preferably not more than 5%. This makes the predominant portion of the light that is coupled into the light conductor available for coupling out of the main scatter surface for illumination purposes.

Depending on the application, it is useful when the angle between the surface normals is greater than 15°, preferably greater than 30° or greater than 45°, in particular greater than 60. By means of an angle between the surface normal greater than 10 an oblique radiation of the coupled out light from the light element is possible to illuminate fixtures which are arranged further away from the light element.

According to another advantageous feature of the invention, the angle between the surface normals is smaller than 70°, preferably smaller than 55° or smaller than 40°, in particular smaller than 25°. With a moderate angle between the surface normals light that is coupled out can be radiated from the light element into the depth of the fixture.

According to another advantageous feature of the invention, the second broadside can have a pattern or relief for coupling out light. This allows achieving a glare free illumination of a surface of an interior fixture and a location lighting for an interior fixture of a vehicle, in particular for a storage place.

According to another advantageous feature of the invention, the relief can include one or multiple grooves, which extend transverse, parallel or perpendicular to a longitudinal extent of the main scatter plane. Due to their contrast rich structure, grooves are a cost effective possibility to create a well visible ambient illumination with a small proportion of surface scattering.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows, schematically, a perspective view onto a cup holder arranged in a center console of a motor vehicle with a light element according to the invention

FIG. 2 shows, schematically, a not to scale front section through the cup holder; and

FIG. 3 shows, schematically, a not to scale detail view of a section along another sectional plane.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

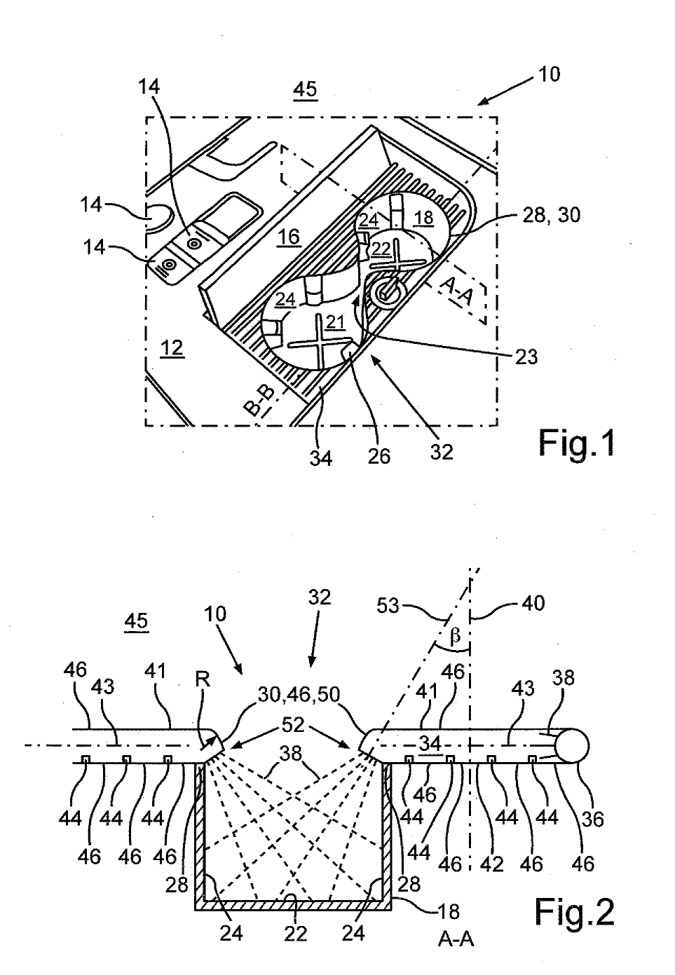

Turning now to the drawing, and in particular to FIG. 1, there is shown a cup holder 10 arranged in a center console 12 of a motor vehicle adjacent control elements 14. The cup holder 10 includes a cover 16 which can be partially folded away and partially retracted. The cover 16 is shown in the retracted position in the Figure. The cup holder 10 includes a container 18 (retraction) with handle shaped layout. The container includes two storage places 21, 22 for placing a respective cup holder (not shown in the figures). Each of the two storage places 21, 22 has three holding clamps 26 at its circumference 24 each with a compression spring (not shown in the figures). The folded out positions of the holding clamps 26 can adjust to cup holder with different diameters by means of their compression springs (for example to coffee-To-Go-paper cups). This avoids tipping over and/or shifting of the cup due to movements of the vehicle. The upper border 28 of the container 18 which is common to both storage places 21, 22 is covered by a border 30 of a section 32 of a light element 34, which forms an end cover plate for the cup holder 10.

The section through the cup holder 10 shown in FIG. 2 extends along the sectional plane A-A shown in FIG. 1. The section extends through the plate shaped light element 34 and through the container 8. Via one or multiple narrow sides of the light element 34, visible light 38 is coupled into the light element 34 by means of one or multiple light sources 36. In order to achieve a coupling in of light 38 that is as even as possible, a light conductor 36 can be provided which is arranged on an outer circumference of the light element 34 (preferably circumferential). The light conductor 36 does not have to be, but is typically wire shaped.

The light element 34 is made of a light conducting plastic, for example PMMA (Poly methyl metachrylate). In addition, or as an alternative, the visible light 38 can also be radiated in via the surface of an inner wall of a (not shown in the Figures) recess of the light element 34 into the light element.

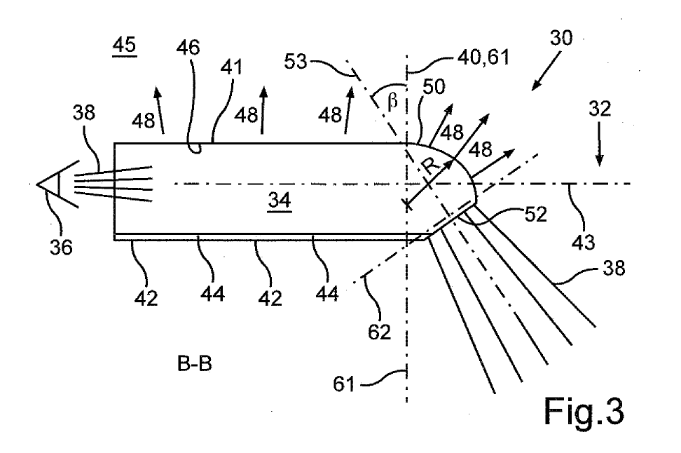

On the bottom side 42 (second broadside) of the light element 34, grooves 44 are milled in longitudinal direction, which are between 0.5 and 1 mm in width. On the grooves 44, light 38 conducted in the light element 34 is scattered. In this way, a portion of the light 38 propagates in a direction in which a total reflection is no longer given, so that this portion of the light 38 exits the light element 34 at is top side 41. This allows recognizing the grooves 44 and with this also the light element 34 also in the dark. As shown in FIG. 3, the grooves 44 can also be oriented in the direction of propagation of the light.

With the light scattering structures 44 in the bottom side 42 of the light element 34 the cup holder 10 contributes to the ambient illumination (ambient light) in the interior of the vehicle 45. beside the cost effective manufacturability, the grooves 44 have the advantage that they concentrate a limited amount of light which his provided for the ambient illumination to a small portion of the total surface of the light element 34 (i.e., to a small portion of the end plate 34). The concentration of the scattering of the light 38 to a few small scatter surfaces 44, which is radiated into the light element 34, an optimal perceptibility of the end plate 34 is also achieved under low light conditions. Due to the high light contrast between the light scattering structures 44 and the total reflection surfaces 46 of the light element 34 that are located between the light scattering structures and are polished on both sides, the ambient illumination appears tidy and clean, because the high contrast to the light scattering structures 44 strongly reduces a perceptibility and/or conspicuousness of leakage light 48, exiting from the top side 41 of the light element 34 on polished surfaces 46. Instead of, or in addition to the grooves 44, other structures (for example Trademark signs) can be worked into the bottom side of the light element 34.

As shown in the detailed sectional drawing of FIG. 3 for a section along the sectional plane B-B (without container 18) shown in FIG. 1, the light element 34 has a polished convex curved portion 50, on a side 41 which faces away from the upper border 28 of the container 18. The curved portion 50 is not mirrored and has a curve radius R which is sufficiently great so that a predominant portion of the light 38 radiated into the light element 34 is not scattered on the curved portion 50 but is further conducted from this point up to a main scatter surface 52 by total reflection. This achieves that leakage radiation losses 48 of visible light 38 which was radiated from the side into the light element 34, in the region of the curved portion 50 are smaller than 6%, preferably not greater than 5%. For example 5% of the total light 38 coupled into the light element 34 is coupled out of the light element 34 as leakage light 48 without prior interaction with one of the scatter surfaces 44, 52 due to incomplete total reflection.

The grooves 44 are visible in daylight when viewing onto the light element 34 and also when the vehicle interior 45 is darkened and the ambient illumination is activated. Due to the fact that the grooves 44 are visible through the top side 41 of the light element 34 and the grooves are arranged on the bottom side 42 of the light element, 34 the light element 34 attains an optical depth with an innovative design appearance.

A main scatter surface 52 is arranged on the border of the section 32 between the curved portion 50 and a bottom side 42 of the light element 34. The main scatter surface 52 forms a bevel between the curved portion 50 and the bottom side 42 of the light element 34. The main scatter surface 52 is oriented obliquely downwards when viewed from the border 30 of the section 32 of the light element 34. The angle β between a surface normal 53 of the main scatter surface 52 and a surface normal 40 of the top side 41 of the light element 34 is between 10° and 80°, for example 45°. The main scatter surface 52 for a single storage space 21, 22 thus has essentially the shape of the sheath surface of an imagined frustrum with the height of several tenth of a millimeter, up to a few millimeters. In the exemplary embodiment of FIG. 1, due to the connecting region 23 between the two storage spaces 21, 22, a segment is left out of the sheath surface of the frustrum over a circumferential length of 8 to 30 millimeters.

More generally, the angle β can be defined in relation to a surface normal 40 of an imagined light distribution plane 43, which is arranged centered between two outer surfaces 41, 42 (broadsides) of the light element 34, wherein the outer surfaces 41, 42 of the light element 34 are capable to conduct visible light 38 between the two outer surfaces 41, 42 of the light element 34, predominantly by total reflection.

The main scatter surface 52 is molded to the section border 30 by means of grinding with an appropriate grinding means or by means of an etching means. This achieves that the interior of the container 18 is illuminated without requiring an additional illumination means.

The described measures achieve that the illumination can be configured glare free and that the storage space 21, 22 for cup holders and its frame (which is formed by the cover plate 34 with its recess 32) can be located easily also when the vehicle interior 45 is darkened. Absence of glare as well as ease of location of the storage space (i.e., of the storage places 21, 22) contribute to traffic safety.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A light element for ambient illumination, comprising:
a light distribution plane;
a main light scatter surface; and
a first broadside and a second broadside arranged essentially parallel to one another, wherein an angle between a surface normal of the main scatter surface and a surface normal of the light distribution plane is within a range from 10° and 80°, and wherein the main scatter surface forms a bevel between a curved portion of the first broadside and the second broadside.

2. The light element of claim 1, wherein the main scatter surface extends along the curved portion of the first broad side, wherein the light element has a first cross section at a beginning of the curved portion and a second cross section directly in front of, but not including a portion of the main scatter surface, and wherein a curve radius of the curved portion is at least of a size so that leakage losses between the first and second cross sections of visible light radiated into the light distribution plane of the light element, are not more than 15%.

3. The light element of claim 2, wherein the leakage losses, are not more than 10%.

4. The light element of claim 2, wherein the leakage losses, are not more than 5%.

5. The light element of claim 2, wherein the main scatter surface has a scatter effect for visible light per surface unit which is at least four times a scatter effect of the curved portion for the visible light per surface unit.

6. The light element of claim 1, wherein the angle between the surface normal of the main scatter surface and the surface normal of the light distribution plane is greater than 15°.

7. The light element of claim 1, wherein the angle between the surface normal of the main scatter surface and the surface normal of the light distribution plane is greater than 30°.

8. The light element of claim 1, wherein the angle between the surface normal of the main scatter surface and the surface normal of the light distribution plane is greater than 40°.

9. The light element of claim 1, wherein the angle between the surface normal of the main scatter surface and the surface normal of the light distribution plane is greater than 60°.

10. The light element of claim 1, wherein the angle between the surface normal of the main scatter surface and the surface normal of the light distribution plane is smaller than 70°.

11. The light element of claim 1, wherein the angle between the surface normal of the main scatter surface and the surface normal of the light distribution plane is greater than 55°.

12. The light element of claim 1, wherein the angle between the surface normal of the main scatter surface and the surface normal of the light distribution plane is greater than 40°.

13. The light element of claim 1, wherein the angle between the surface normal of the main scatter surface and the surface normal of the light distribution plane is greater than 25°.

14. The light element of claim 1, wherein the second broadside has a pattern or relief for scattering and coupling out light.

15. The light element of claim 14, wherein the relief includes one or multiple grooves, said grooves extending transversely or perpendicular to a longitudinal extent of the main scatter surface.

16. A fixture for a motor vehicle, comprising a light element, said light element comprising a light distribution plane, a main light scatter surface, a first broadside and a second broadside, wherein an angle between a surface normal of the main scatter surface and a surface normal of the light distribution plane is between 10° and 80°, wherein the first and second broadsides are arranged essentially parallel to one another, and wherein the main scatter surface forms a bevel between a curved portion of the first broadside and the second broadside.

17. A motor vehicle, comprising a light element, said light element comprising a light distribution plane, a main light scatter surface, a first broadside and a second broadside, wherein an angle between a surface normal of the main scatter surface and a surface normal of the light distribution plane is between 10° and 80°, wherein the first and second broadsides are arranged essentially parallel to one another, and wherein the main scatter surface forms a bevel between a curved portion of the first broadside and the second broadside.
